(19) United States
(12) Patent Application Publication
(10) Pub. No.: US 2018/0273004 A1
(43) Pub. Date: Sep. 27, 2018

(54) VALVE SYSTEM AND METHOD FOR CONTROLLING SAME

(71) Applicant: Bendix Commercial Vehicle Systems LLC, Elyria, OH (US)

(72) Inventors: Paul C. Niglas, Avon, OH (US); Michael D. Tober, Avon, OH (US); Randy J. Salvatora, North Olmsted, OH (US)

(21) Appl. No.: 15/470,225

(22) Filed: Mar. 27, 2017

(51) Int. Cl. B60T 8/17; B60T 7/20; B60T 13/68; B60T 15/18; B60T 15/54

(52) U.S. Cl. CPC B60T 8/1708; B60T 7/20; B60T 15/54; B60T 15/18; B60T 13/683

(57) ABSTRACT

A valve system includes a control module on a tractor portion of a vehicle adapted to receive a supply pressure as a control module supply pressure of the pneumatic fluid, receive a control module control pressure of the pneumatic fluid, and deliver a control module delivery pressure of the pneumatic fluid based on the control module supply pressure and the control module control pressure. A park control module selectively transmits the pneumatic fluid at the supply pressure based on a park brake control signal. A supply glad-hand fluidly communicates the selectively transmitted supply pressure of the pneumatic fluid to supply a brake on an associated trailer portion of the vehicle. A control glad-hand fluidly communicates the control module delivery pressure of the pneumatic fluid to control the brake on the associated trailer portion of the vehicle. An exhaust valve, which fluidly communicates with both the selectively transmitted supply pressure and the control module delivery pressure, exhausts the control module delivery pressure of the pneumatic fluid from the control glad-hand.

### BACKGROUND

The present invention relates to a tractor protection function. It finds particular application in conjunction with delivering pneumatic fluid from a tractor to a trailer based on a trailer park brake pressure and will be described with particular reference thereto. It will be appreciated, however, that the invention is also amenable to other applications.

Current trailer control strategies involve using a relay valve to apply full system air pressure to a supply port of an antilock braking system (ABS) modulator. The ABS modulator is set to hold off pressure, and pulses to send a set volume of air into the trailer control line to apply trailer brakes. Check valves are currently used at respective delivery ports of air reservoirs to protect pressure in the reservoirs in the event of a downstream failure (e.g., an air leak) in the air system. However, there is no mechanism to compensate for any loss of air volume in the trailer and/or verify that the required air pressure has been delivered to the trailer.

The present invention provides a new and improved apparatus and method for compensating for any loss of air volume in the trailer and/or verifying that the required air pressure has been delivered to the trailer.

### SUMMARY

In one aspect of the present invention, it is contemplated that a valve system includes a control module on a tractor portion of a vehicle adapted to receive a supply pressure as a control module supply pressure of the pneumatic fluid, receive a control module control pressure of the pneumatic fluid, and deliver a control module delivery pressure of the pneumatic fluid based on the control module supply pressure and the control module control pressure. A park control module selectively transmits the pneumatic fluid at the supply pressure based on a park brake control signal. A supply glad-hand fluidly communicates the selectively transmitted supply pressure of the pneumatic fluid to supply a brake on an associated trailer portion of the vehicle. A control glad-hand fluidly communicates the control module delivery pressure of the pneumatic fluid to control the brake on the associated trailer portion of the vehicle. An exhaust valve, which fluidly communicates with both the selectively transmitted supply pressure and the control module delivery pressure, exhausts the control module delivery pressure of the pneumatic fluid from the control glad-hand.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a simplified component diagram of an exemplary valve system in a first state while an associated vehicle is in a first state in accordance with one embodiment of an apparatus illustrating principles of the present invention;

FIG. 2 illustrates a schematic representation of a simplified component diagram of an exemplary valve system in the first state while the associated vehicle is in a second state in accordance with one embodiment of an apparatus illustrating principles of the present invention;

FIG. 3 is an exemplary methodology of controlling the valve system in accordance with one embodiment illustrating principles of the present invention;

FIG. 4 illustrates a schematic representation of a simplified component diagram of an exemplary valve system in a second state while the associated vehicle is in the second state in accordance with one embodiment of an apparatus illustrating principles of the present invention; and

FIG. 5 illustrates a schematic representation of a simplified component diagram of an exemplary valve system in a third state while the associated vehicle is in the second state in accordance with one embodiment of an apparatus illustrating principles of the present invention.

### DETAILED DESCRIPTION OF ILLUSTRATED EMBODIMENT

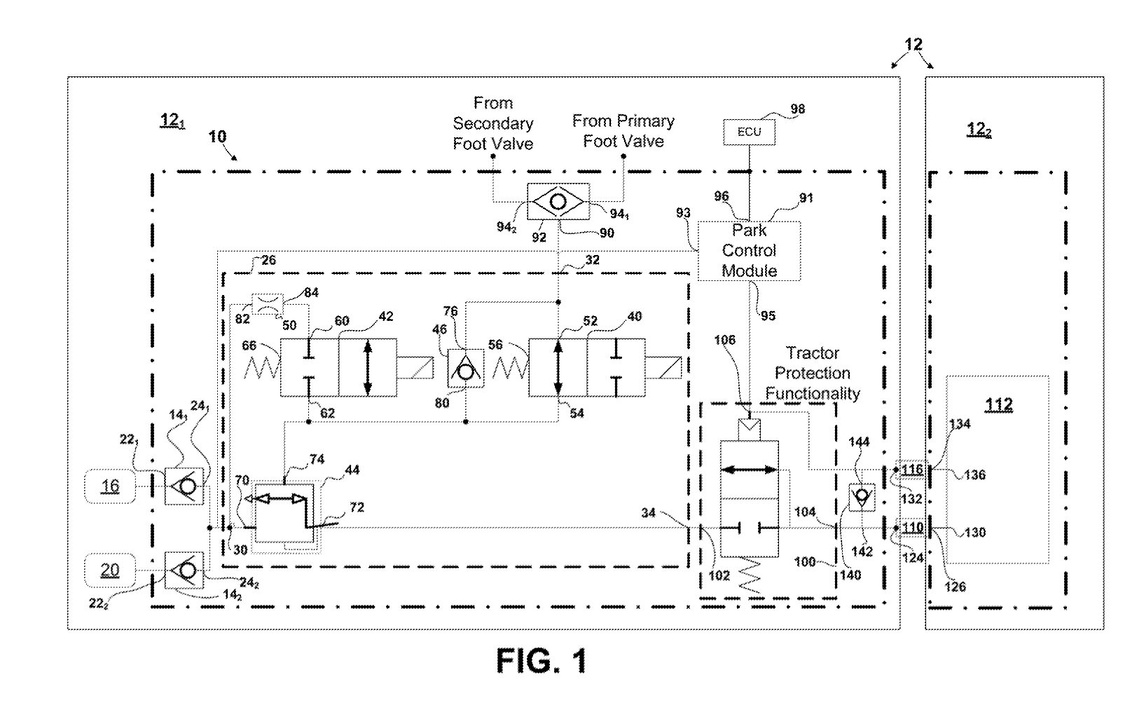

With reference to FIG. 1, a simplified component diagram of an exemplary valve system 10 is illustrated in accordance with one embodiment of the present invention. The valve system 10 is part of an associated vehicle 12, which includes a tractor 12₁ and a trailer 12₂, and includes at least one isolation check valve 14₁, 14₂ (e.g., two (2) check valves collectively referenced as 14). The first isolation check valve 14₁ receives a pneumatic fluid (e.g., air) from a first source such as, for example, a first reservoir 16, and the second isolation check valve 14₂ receives the pneumatic fluid from a second source such as, for example, a second reservoir 20. It is to be assumed that the first and second reservoirs 16, 20 are part of respective fluidly independent pneumatic circuits . The first isolation check valve 14₁ includes a first pneumatic supply port 22₁ and a first pneumatic delivery port 24₁. The second isolation check valve 14₂ includes a second pneumatic supply port 22₂ and a second pneumatic delivery port 24₂. The first pneumatic delivery port 24₁ fluidly communicates with the second pneumatic delivery port 24₂. A higher of the respective pressures (e.g., supply pressures) of the pneumatic fluid at the first and second pneumatic supply ports 22_{1,2} is present at both the first and second pneumatic delivery ports 24_{1,2}.

A control module 26 includes a supply port 30, a control port 32, and a delivery port 34. The control module 26 also includes a first control valve 40, a second control valve 42, a relay valve 44, a control module check valve 46, and a restrictor 50. The first control valve 40 includes a supply port 52 (e.g., a pneumatic supply port), a delivery port 54 (e.g., a pneumatic delivery port) and a control port 56 (e.g., an electrical control port). The second control valve 42 includes a supply port 60 (e.g., a pneumatic supply port), a delivery port 62 (e.g., a pneumatic delivery port) and a control port 66 (e.g., an electrical control port). The relay valve 44 includes a supply port 70 (e.g., a pneumatic supply (input) port), a delivery port 72 (e.g., a pneumatic delivery (output) port), and a control port 74 (e.g., a pneumatic control port). The check valve 46 includes a pneumatic supply port 76 (e.g., input port) and a pneumatic delivery port 80 (e.g., output port). The restrictor 50 includes an pneumatic supply port 82 (e.g., input port) and a pneumatic delivery port 84 (e.g., output port).

In the illustrated embodiment, both the relay valve supply port 70 and the restrictor input port 82 fluidly communicate with the control module supply port 30. Both the first control valve supply port 52 and the check valve supply port 76 fluidly communicate with the control module control port 32. Each of the first control valve delivery port 54, the second control valve delivery port 62 and the check valve delivery port 80 fluidly communicates with relay valve control port 74. The check valve 46 opens to permit fluid communication between the check valve supply port 76 and the check valve delivery port 80 when a pressure of the pneumatic fluid at the check valve supply port 76 is greater than a pressure at the check valve delivery port 80; otherwise, the check valve 46 remains closed to prevent fluid communication between the check valve supply port 76 and the check valve delivery port 80. The relay valve delivery port 72 fluidly communicates with the control module delivery port 34.

The higher of the respective supply pressures of the pneumatic fluid at the first and second pneumatic supply ports 22_{1,2}, which is present at both the first and second pneumatic delivery ports 24_{1,2}, is fluidly communicated to the control module supply port 30 as a control module supply pressure. The control module supply pressure is, therefore, fluidly communicated to the restrictor input port 82 and the relay valve supply port 70. The restrictor output port 84 fluidly communicates the control module supply pressure to the second control valve supply port 60. The restrictor 50 slows airflow from the first and second reservoirs 16, 20 to help control the second control valve 42. In addition, the restrictor 50 allows a leak from the supply port 60 to the control port 62 of the second control valve 42 to exhaust through the delivery port 54 of the first control valve 40 before such a leak acts on the control port 74 of the relay valve 44.

The control module control port 32 receives a pneumatic control signal, based on a level of operator demanded braking, from an output port 90 of a double check valve 92. For example, the operator of an associated vehicle 12 depresses a pedal of a foot valve (not shown) to demand braking. The level of the operator demanded braking is dependent on an amount the pedal is depressed. The pneumatic fluid from the first and second reservoirs 16, 20 is fluidly transmitted to respective first and second input ports 94₁, 94₂ of the double check valve 92 based on the level of operator demanded braking. The higher of the respective pneumatic pressures at the first and second input ports 94₁, 94₂ is fluidly communicated to the double check valve output port 90 and, therefore, to the control module control port 32. The higher of the respective pneumatic pressures at the first and second input ports 94₁, 94₂ is also fluidly communicated from the control module control port 32 to both the first control valve supply port 52 and the check valve supply port 76.

A park control module 91 includes a supply port 93, a delivery port 95, and a control port 96. In one embodiment, the park control module supply port 93 and the park control module delivery port 95 are pneumatic ports, and the park control module control port 96 is an electronic port. However, any combination of pneumatic and electronic ports are contemplated for the park control module supply port 93, the park control module delivery port 95 and the park control module control port 96. The park control module supply port 93 fluidly communicates with both the control module supply port 30 and the relay valve supply port 70. Therefore, the pneumatic pressure at the park control module supply port 93 is substantially equal to the pneumatic pressure at both the control module supply port 30 and the relay valve supply port 70. The park control module control port 96 electrically communicates with an electronic control unit 98.

The ECU 98 electrically transmits an electronic control signal to the park control module control port 96 based on a desired status of the park brakes (not shown) of the trailer 12₂. For example, the ECU 98 receives a command (e.g., an electrical command) from an operator of the vehicle 12 to either engage the park brakes of the trailer 12₂ (e.g., set the trailer 12₂ to the parked state) or disengage the park brakes of the trailer 12₂ (e.g., set the trailer 12₂ to the unparked state). If the park brakes of the trailer 12₂ are not desired to be engaged, the ECU 98 electrically transmits a first electronic control signal to the park control module control port 96; and if the park brakes of the trailer 12₂ are desired to be engaged, the ECU 98 electrically transmits a second electronic control signal to the park control module control port 96. It is contemplated that the first electronic signal is the absence of an electric signal (e.g., an electric signal less than a predetermined voltage), and the second electronic signal is the presence of an electric signal (e.g., an electric signal at least the predetermined voltage).

The park control module supply port 93 selectively fluidly communicates with the park control module delivery port 95 based on the electronic control signal at the park control module control port 96 (e.g., a park brake control signal). For example, if the park brakes of the trailer 12₂ are desired to be engaged (e.g., if the associated vehicle 12 is desired to be in a parked state), the first electronic signal is transmitted from the ECU 98 to the park control module control port 96 and the park control module supply port 93 is selected to not fluidly communicate with the park control module delivery port 95. Otherwise, if the park brakes of the tractor 12₁ are desired to not be engaged (e.g., if the associated vehicle 12 is desired to be in an unparked state), the second electronic signal is transmitted from the ECU 98 to the park control module control port 96 and the park control module supply port 93 is selected to fluidly communicate with the park control module delivery port 95.

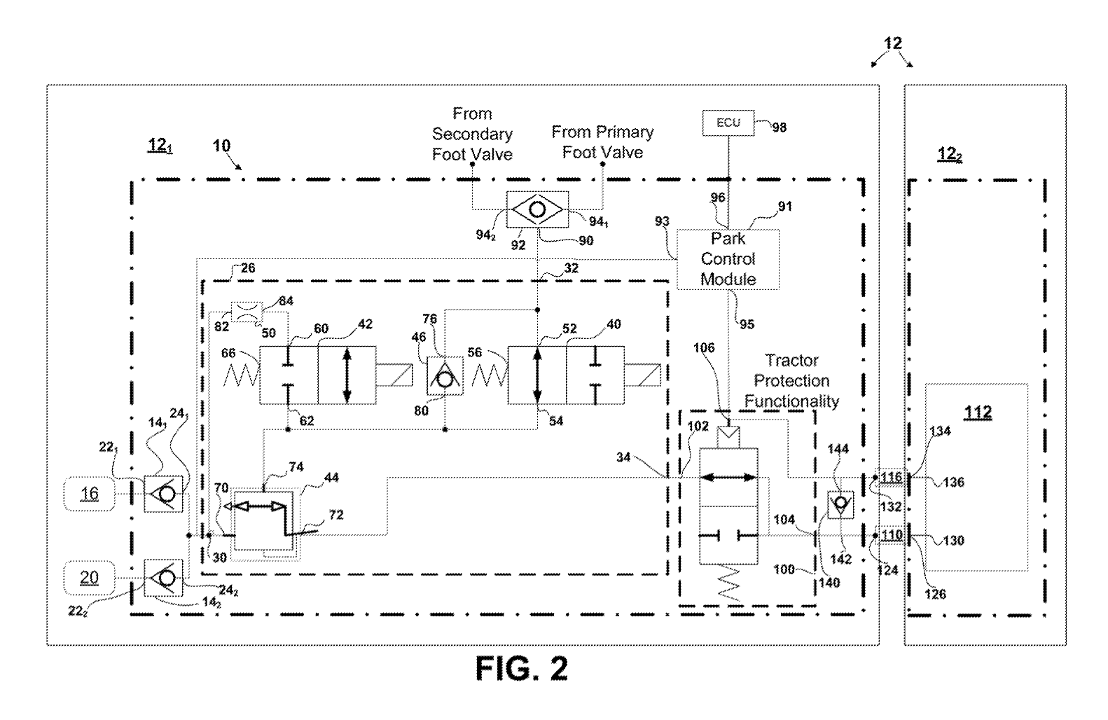

A tractor protection module 100 includes a supply port 102 (e.g., input), a delivery port 104 (e.g., output) and a control port 106. The tractor protection supply port 102 fluidly communicates with the tractor protection delivery port 104 based on a pneumatic pressure at the tractor protection control port 106. In the illustrated embodiment, the tractor protection control port 106 fluidly communicates with the park control module delivery port 95. The pneumatic pressure at the tractor protection control port 106 is referred to as a trailer park brake pneumatic pressure. The trailer park brake pneumatic pressure at the tractor protection control port 106 (e.g., trailer park brake pressure) is at least a predetermined threshold if the associated vehicle 12 is in an unparked state (see FIG. 2) and below the predetermined threshold if the associated vehicle 12 is in a parked state (see FIG. 1). While the vehicle 12 is in the unparked state (see FIG. 2), the tractor protection supply port 102 fluidly communicates with the tractor protection delivery port 104 so that the pneumatic pressure at the tractor protection supply port 102 is fluidly communicated to the tractor protection delivery port 104, during which time the tractor protection module is also in an unparked state. While the vehicle 12 is in the parked state, as illustrated in FIG. 1, the tractor protection supply port 102 does not fluidly communicate with the tractor protection delivery port 104, during which time the tractor protection module is also in an parked state.

Each of a control glad-hand 110 and a supply glad-hand 116 fluidly communicates with a trailer brake system 112 on the trailer 12₂ of the vehicle 12. The control glad-hand 110 includes a supply port 124, which fluidly communicates with the tractor protection delivery port 104 of the tractor protection module 100, and a delivery port 126, which fluidly communicates with a control port 130 of the trailer brake system 112. The supply glad-hand 116 includes a supply port 132, which fluidly communicates with the tractor protection control port 106, and a delivery port 134, which fluidly communicates with a supply port 136 of the trailer brake system 112.

A tractor protection check valve 140 is fluidly positioned between the control glad-hand supply port 124 and the supply glad-hand supply port 132. More specifically, a supply port 142 of the tractor protection check valve 140 fluidly communicates with the control glad-hand supply port 124 and, consequently, also the tractor protection delivery port 104. In addition, a delivery port 144 of the tractor protection check valve 140 fluidly communicates with the supply glad-hand supply port 132 and, consequently, also the tractor protection control port 106.

When the associated vehicle 12 changes from the unparked state (see FIGS. 2, 4 and 5) to the parked state (see FIG. 1), the tractor protection delivery port 104 of the tractor protection module 100 stops from fluidly communicating with the tractor protection supply port 102. Although the tractor protection delivery port 104 continues to fluidly communicate with the control glad-hand supply port 124 and the tractor protection check valve supply port 142 while the associated vehicle 12 is in the parked state (see FIG. 1), any pneumatic fluid at the tractor protection delivery port 104 cannot fluidly communicate with the tractor protection supply port 102. Therefore, without the tractor protection check valve 140, any pneumatic fluid at the tractor protection delivery port 104, the control glad-hand supply port 124 and the tractor protection check valve supply port 142 becomes “trapped” and cannot escape when the associated vehicle 12 changes from the unparked state (see FIGS. 2, 4 and 5) to the parked state (see FIG. 1).

However, in the illustrated embodiment, any pneumatic fluid trapped at the tractor protection delivery port 104, the control glad-hand supply port 124 and/or the tractor protection check valve supply port 142 may be exhausted via the tractor protection check valve 140. More specifically, if the pressure of the pneumatic fluid at the tractor protection check valve supply port 142 is at least a tractor protection check valve cracking pressure, the pneumatic fluid is exhausted via the tractor protection check valve delivery port 144 until the pneumatic pressure at the tractor protection check valve supply port 142 drops below the tractor protection check valve cracking pressure. Therefore, the tractor protection check valve 140 is referred to as an exhaust valve.

Pneumatic pressure trapped at the control glad-hand supply port 124 may cause service brakes on the trailer 12₂ to actuate at undesirable times. For example, it is undesirable to simultaneously engage both the service brakes and the park brakes on, for example, the trailer 12₂, which is referred to as brake compounding. Therefore, the park control module 91, the tractor protection module 100 and the tractor protection check valve 140 act as a means for preventing compounding (e.g., anti-compounding) the service brakes and the park brakes on the trailer 12₂.

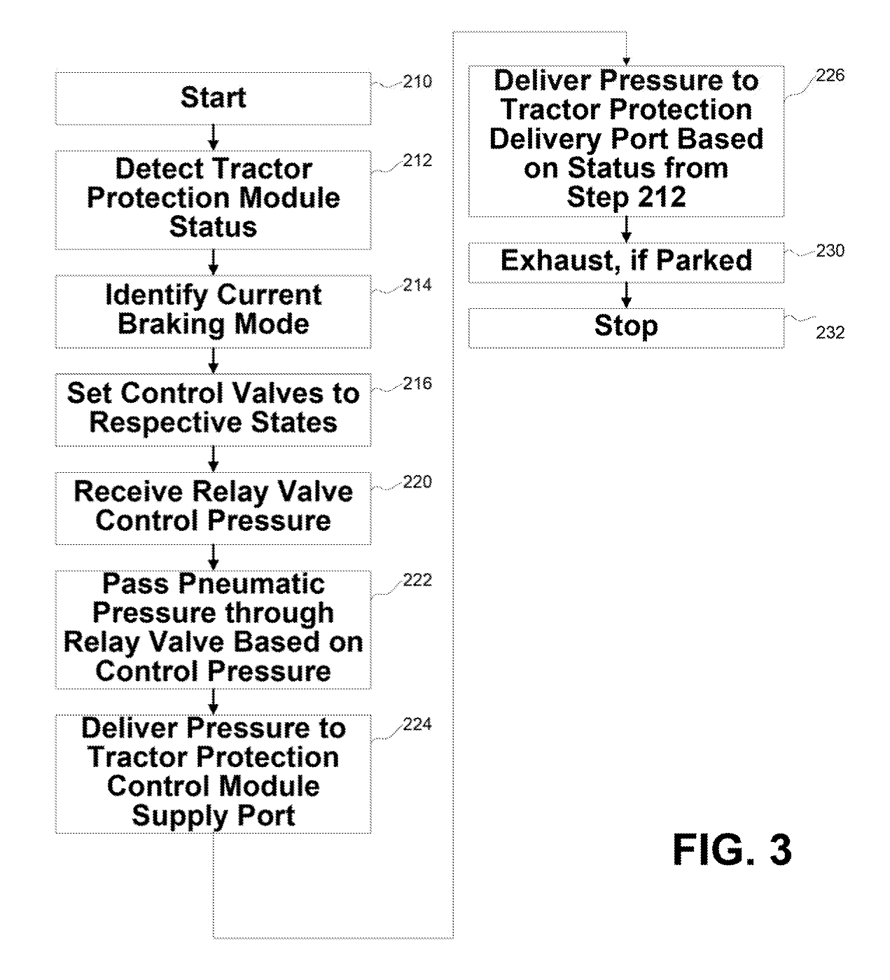

With reference to FIG. 3, an exemplary methodology of the operation of the valve system 10 shown in FIGS. 1, 2, 4 and 5 is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

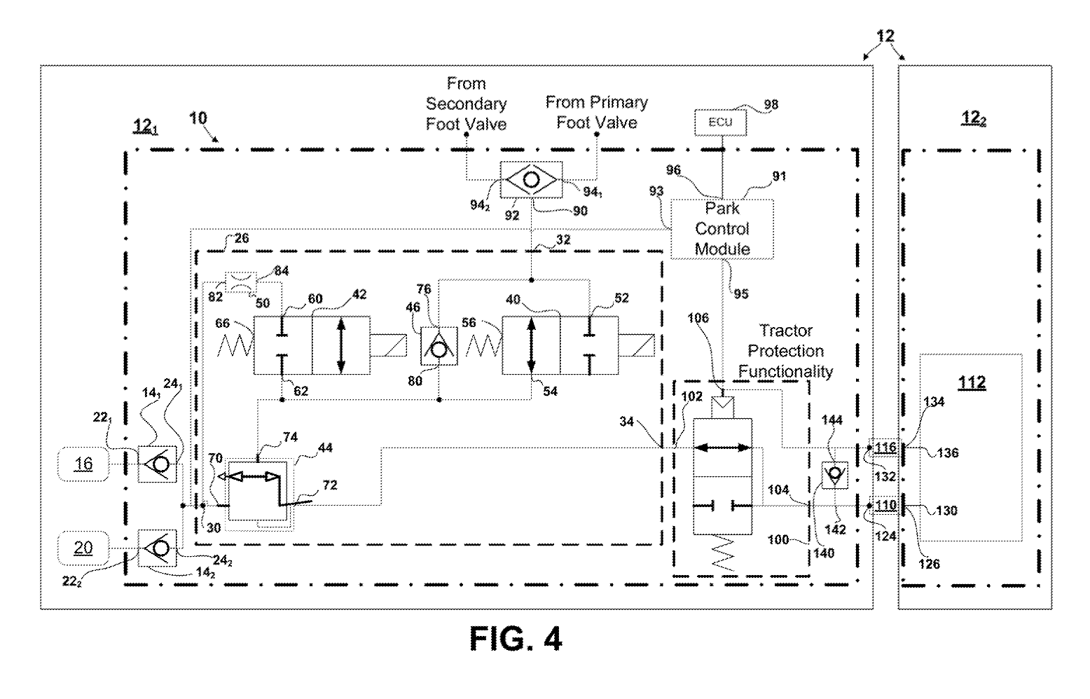

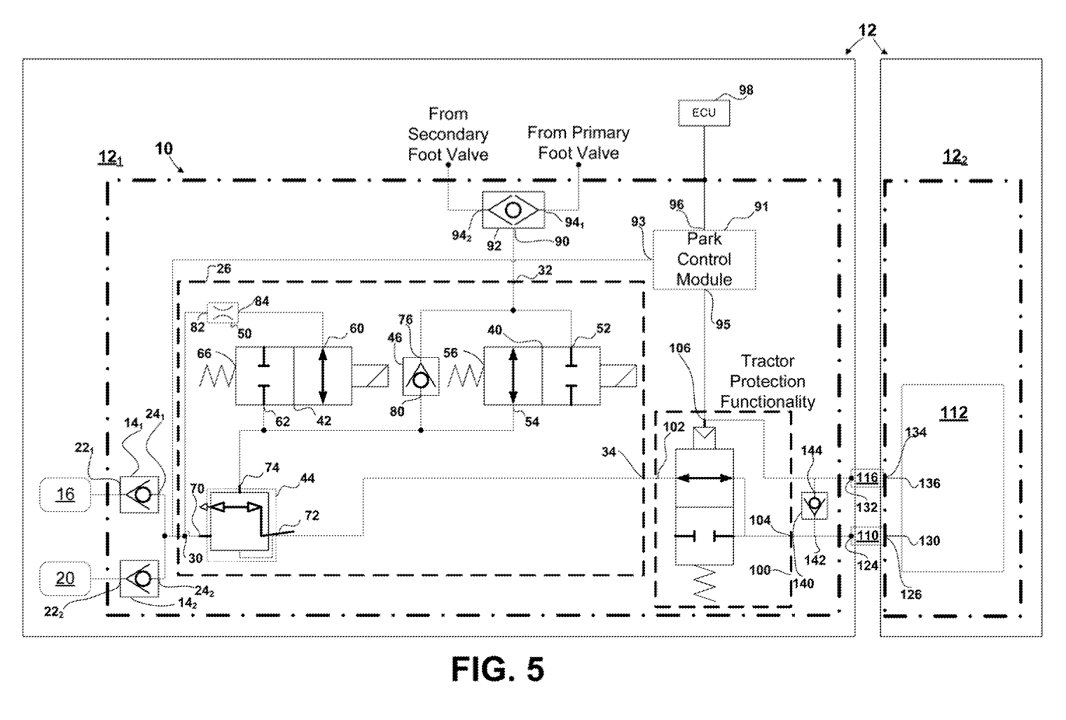

With reference to FIGS. 1-5, the operation starts in a step 210. Then, in a step 212, the status of the tractor protection module 100 is detected. For example, the status of the park brakes (not shown) of the trailer 12₂ is set in the step 212 as either “unparked” or “parked.” More specifically, the ECU 98 electrically transmits the electronic control signal to the park control module control port 96 based on the desired status of the park brakes of the trailer 12₂ and the park control module 91 receives the electronic control signal. In a step 214, a current braking mode is determined. For example, one of the following three (3) current braking modes is identified in the step 214: an operator initiated braking mode (see FIGS. 1 and 2), a system increasing pressure mode (see FIG. 5), and a system holding pressure mode (see FIG. 4). During the operator initiated braking mode (see FIGS. 1 and 2), the amount of braking of the associated vehicle 12 is based on how much the operator depresses the pedal of the foot valve. During the system increasing pressure mode (see FIG. 5), the amount of braking of the associated vehicle 12 is being increased by an automatic braking system (e.g., antilock braking system (ABS), electronic braking system (EBS), etc). During the system holding pressure mode (see FIG. 4), the amount of braking of the associated vehicle 12 is being held by the automatic braking system (e.g., antilock braking system (ABS), electronic braking system (EBS), etc).

Then, in a step 216, the first and second control valves 40, 42, respectively, are set to respective states based on the current braking mode. For example, if the current braking mode is the operator initiated braking mode (see FIGS. 1 and 2), then in the step 216 the first control valve 40 is set to an open state and the second control valve 42 is set to a closed state. If the current braking mode is the system increasing pressure mode (see FIG. 5), then in the step 216 the first control valve 40 is set to a closed state and the second control valve 42 is set to an open state. If the current braking mode is the system holding pressure mode (see FIG. 4), then in the step 216 both the first and second control valves 40, 42, respectively, are set to the closed state.

While in the open state, the first control valve 40 is set so that the first control valve supply port 52 fluidly communicates with the first control valve delivery port 54. Similarly, while in the open state, the second control valve 42 is set so that the second control valve supply port 60 fluidly communicates with the second control valve delivery port 62. While in the closed state, the first control valve 40 is set so that the first control valve supply port 52 does not fluidly communicate with the first control valve delivery port 54. Similarly, while in the closed state, the second control valve 42 is set so that the second control valve supply port 60 does not fluidly communicate with the second control valve delivery port 62.

In a step 220, the relay valve control port 74 receives a relay valve control pressure from at least one of the first control valve 40, the second control valve 42 and the check valve 46. For example, if the first control valve 40 is set to the open state and the second control valve 42 is set to a closed state (e.g., if the current braking mode is the operator initiated braking mode), the relay valve control pressure is received from the first control valve 40 and represents the level of operator demanded braking. If the first control valve 40 is set to the closed state and the second control valve 42 is set to a open state (e.g., if the current braking mode is the system increasing pressure braking mode), the relay valve control pressure is received from the second control valve 42 and represents the level of system demanded braking. If both the first control valve 40 is set to the closed state and the second control valve 42 is set to a closed state (e.g., if the current braking mode is the system holding pressure braking mode), the relay valve control pressure is received from the check valve 46 and represents the level of system demanded braking during, for example, a hill start assist.

In a step 222, the relay valve 44 passes the pneumatic pressure at the control module supply port 30 to the control module delivery port 34 based on the pneumatic pressure received at the relay valve control port 74.

In another embodiment, the pneumatic pressure passed from the control module supply port 30 to the control module delivery port 34 changes (e.g., proportionally) as the pneumatic pressure at the relay valve control port 74 changes. For example, the pneumatic pressure delivered from the control module supply port 30 to the control module delivery port 34 changes (e.g., proportionally) as the pneumatic pressure at relay valve control port 74 increases or decreases. It is also contemplated that the pneumatic pressure delivered from the control module supply port 30 to the control module delivery port 34 changes linearly as the pneumatic pressure at relay valve control port 74 increases or decreases.

In a step 224, the pneumatic pressure at the control module delivery port 34 is delivered to the control module delivery port 34 and, consequently, the tractor protection module supply port 102.

Then, in a step 226, the pneumatic pressure at the tractor protection module supply port 102 is delivered to the tractor protection delivery port 104 based on the status of the tractor protection module 100 detected in the step 212. For example, if the status of the tractor protection module 100 is unparked (see FIG. 2), the pneumatic pressure at the tractor protection delivery port 104 is transmitted, during the step 226, to the control glad-hand 110, which fluidly communicates with the trailer brake system 112 on the trailer 12₂ of the vehicle 12. The supply glad-hand 116 fluidly communicates with trailer brake system 112. The trailer brake system 112 on the trailer 12₂ is controlled based on the pneumatic pressure delivered from the tractor protection delivery port 104. On the other hand, if the status of the tractor protection module 100 is parked (see FIG. 1), the pneumatic pressure at the tractor protection delivery port 104 is not transmitted to the control glad-hand 110 during the step 226.

In addition, if the status of the tractor protection module 100 is parked (see FIG. 1), the pneumatic pressure at the tractor protection delivery port 104 and the control glad-hand supply port 124 is exhausted via the tractor protection check valve 140 in a step 230. Therefore, the step 230 ensures compounding of the service brakes and the park brakes on the trailer 12₂ does not occur.

The operation stops in a step 232.

In one embodiment, it is contemplated that the at least one isolation check valve 14, the first control valve 40, the second control valve 42, the control module check valve 46, the relay valve 44, the park control module 91 and the tractor protection module 100 act as a means for controlling the pressure at the delivery port 104 of the tractor protection module 100.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. A valve system, including:
a control module on a tractor portion of a vehicle, the control module adapted to:
receive a supply pressure as a control module supply pressure of the pneumatic fluid;
receive a control module control pressure of the pneumatic fluid; and
deliver a control module delivery pressure of the pneumatic fluid based on the control module supply pressure and the control module control pressure;
a park control module selectively transmitting the pneumatic fluid at the supply pressure based on a park brake control signal; and
a supply glad-hand fluidly communicating the selectively transmitted supply pressure of the pneumatic fluid to supply a brake on an associated trailer portion of the vehicle;
a control glad-hand fluidly communicating the control module delivery pressure of the pneumatic fluid to control the brake on the associated trailer portion of the vehicle; and
an exhaust valve, fluidly communicating with both the selectively transmitted supply pressure and the control module delivery pressure, exhausting the control module delivery pressure of the pneumatic fluid from the control glad-hand.

2. The valve system as set forth in claim 1, wherein:
the exhaust valve exhausts the pneumatic fluid trapped at a supply port of the exhaust valve after control module no longer delivers the control module delivery pressure.

3. The valve system as set forth in claim 1, wherein:
the control module delivery pressure of the pneumatic fluid rises above the cracking pressure of the exhaust valve when the park control module selectively exhausts the supply pressure of the pneumatic fluid transmitted to the supply glad-hand.

4. The valve system as set forth in claim 3, wherein:
the park control module selectively exhausts the supply pressure of the pneumatic fluid transmitted to the supply glad-hand when a park brake of the trailer portion of the vehicle is engaged.

5. The valve system as set forth in claim 4, further including:
a tractor protection valve set to one of a parked state and an unparked state based on the supply pressure of the pneumatic fluid transmitted from the park control module, the tractor protection valve delivering the control module delivery pressure to the control glad-5 hand based on the state of the tractor protection valve.

6. The valve system as set forth in claim 4, wherein:
selectively exhausting the supply pressure of the pneumatic fluid transmitted to the supply glad-hand when a park brake of the tractor portion of the vehicle is engaged provides anti-compounding of a service brake and the park brake.
